(19) United States
(12) Patent Application Publication
(10) Pub. No.: US 2015/0159815 A1
(43) Pub. Date: Jun. 11, 2015

(54) DIRECT-TYPE ILLUMINATION DEVICE AND LIGHT BAR STRUCTURE FOR USE THEREIN

(71) Applicant: LEXTAR ELECTRONICS CORPORATION, Hsinchu (TW)

(72) Inventor: Chin-Chang Hsu, Pingtung County (TW)

(73) Assignee: LEXTAR ELECTRONICS CORPORATION, Hsinchu (TW)

(21) Appl. No.: 14/260,219

(22) Filed: Apr. 23, 2014

(30) Foreign Application Priority Data
Dec. 10, 2013 (TW) 102145303

(51) Int. Cl. F21K 99/00

(52) U.S. Cl. CPC F21K 9/17

(57) ABSTRACT

A light bar structure is disclosed. A light source module is disposed on a circuit board. At least two power input portions are disposed on the circuit board and are in parallel connection. The at least two power input portions are electrically connected to the light source module.

### CROSS REFERENCE TO RELATED APPLICATIONS

This Application claims priority of Taiwan Patent Application No. 102145303, filed on Dec. 10, 2013, the entirety of which is incorporated by reference herein.

### BACKGROUND OF THE INVENTION

1. Field of the Invention

The invention relates to a light bar structure, and more particularly to a direct-type illumination device.

2. Description of the Related Art

Referring to FIG. 1, a conventional light bar structure 1 comprises a circuit board 10, a light source module, and a power input portion 30.

The light source module is disposed on the circuit board 10. Here, the light source module comprises a plurality of light-emitting diodes 20.

The power input portion 30 is disposed on the circuit board 10 and is electrically connected to the light-emitting diodes 20 of the light source module. Here, the power input portion 30 is often disposed on or near a single side of the circuit board 10.

When being assembled on a holder, multiple light bar structures 1 must be arranged to face the same direction (i.e. the positions of the power input portions 30 of the light bar structures 1 must correspond to each other), facilitating electrical connection between the power input portions 30 of the light bar structures 1. As shown in FIG. 2, when two adjacent light bar structures 1 are not arranged to face toward the same direction in advance, the power input portions 30 of the two adjacent light bar structures 1 are staggered and are separated away from each other. At this point, after the multiple light bar structures 1 are assembled on a holder 2, the electrical connection between the power input portions 30 becomes complicated. Specifically, as shown in FIG. 2, as the power input portions 30 of the two adjacent light bar structures 1 are electrically connected to each other by a wire W, the staggered power input portions 30, which are separated away from each other, result in the lengthy wire W, causing difficulties of wire management during assembly of the light bar structures 1 and holder 2.

Moreover, in each light bar structure 1, as the power input portion 30 is disposed on a single side of the circuit board 10, an impedance of the light-emitting diode 20 far away from the power input portion 30 exceeds that of the light-emitting diode 20 near the power input portion 30, thereby causing an uneven distribution of illumination brightness for the light bar structure 1.

Hence, there is a need for a direct-type illumination device that can be easily assembled and provide improved uniformity of illumination brightness.

### BRIEF SUMMARY OF THE INVENTION

A detailed description is given in the following embodiments with reference to the accompanying drawings.

An exemplary embodiment of the invention provides a light bar structure comprising a circuit board, a light source module, and at least two power input portions. The light source module is disposed on the circuit board. The at least two power input portions are disposed on the circuit board and are in parallel connection. The at least two power input portions are electrically connected to the light source module.

The at least two power input portions are symmetrical to a center of the circuit board.

Each power input portion comprises a connector or two solder wire contacts.

The circuit board comprises at least one fixing portion assisting in fixing the light bar structure.

The light source module comprises a plurality of parallel light-emitting diodes in parallel connection with the at least two power input portions.

Another exemplary embodiment of the invention provides a direct-type illumination device comprising a holder and a light bar structure. The light bar structure is disposed on the holder and comprises a circuit board, a light source module, and at least two power input portions. The light source module is disposed on the circuit board. The at least two power input portions are disposed on the circuit board and are in parallel connection. The at least two power input portions are electrically connected to the light source module.

The circuit board comprises at least one fixing portion fixing the light bar structure to the holder.

### BRIEF DESCRIPTION OF THE DRAWINGS

The invention can be more fully understood by reading the subsequent detailed description and examples with references made to the accompanying drawings, wherein:

FIG. 1 is a schematic plane view of a conventional light bar structure;

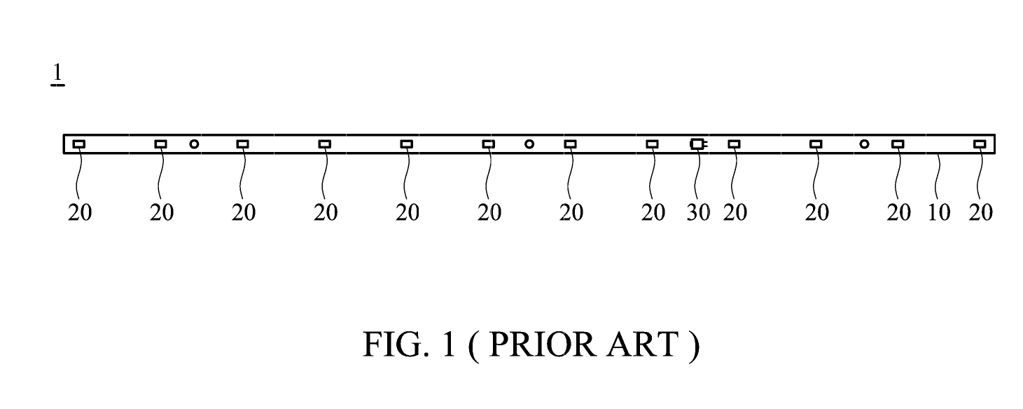

FIG. 2 is a schematic plane view showing multiple conventional light bar structures assembled on a holder;

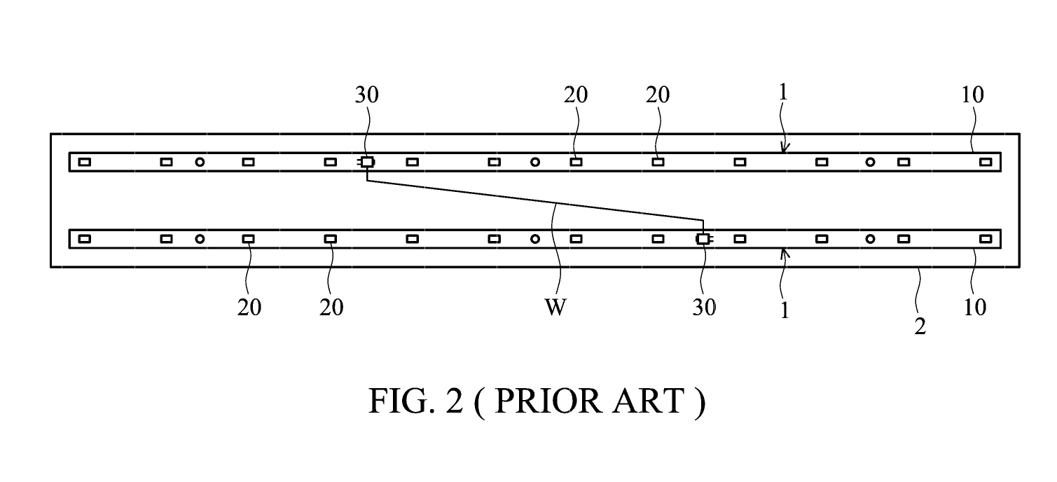

FIG. 3 is a schematic plane view of a light bar structure of the invention; and

FIG. 4 is a schematic plane view of a direct-type illumination device of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

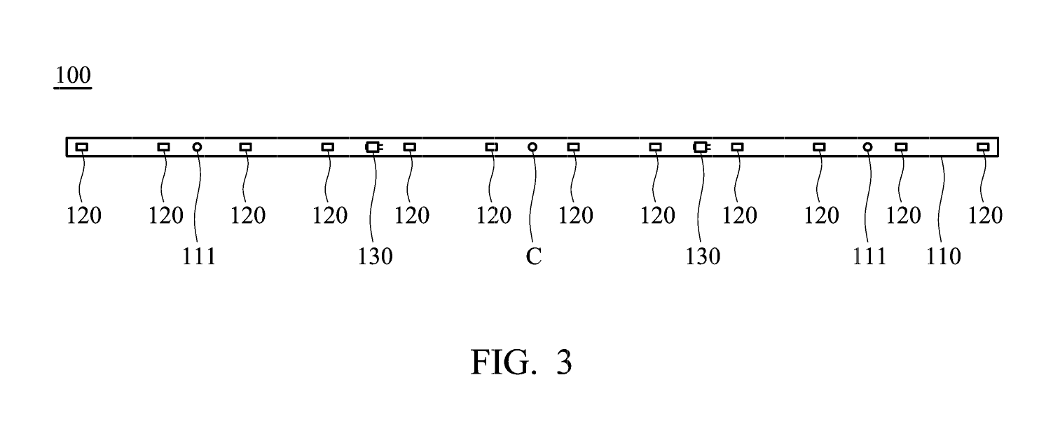

Referring to FIG. 3, a light bar structure 100 comprises a circuit board 110, a light source module, and at least two power input portions 130.

The circuit board 110 comprises a plurality of fixing portions 111 assisting in fixing the light bar structure 100.

The light source module is disposed on the circuit board 110. In this embodiment, the light source module may be composed of a plurality of parallel light-emitting diodes 120.

The power input portions 130 are disposed on the circuit board 110 and are in parallel connection. Here, the power input portions 130 are electrically connected to the light source module. Specifically, the power input portions 130 are electrically connected to the light-emitting diodes 120 of the light source module and the light-emitting diodes 120 are in parallel connection with the power input portions 130. It is noted that the power input portions 130 are symmetrical to a center C of the circuit board 110. Moreover, each power input portion 130 may be a connector or comprise two solder wire contacts. For example, as shown in FIG. 3, the power input portions 130 in this embodiment are connectors. Additionally, the light bar structure 100 is not limited to having two power input portions 130. Namely, the light bar structure 100 may selectively comprise more than two power input portions 130.

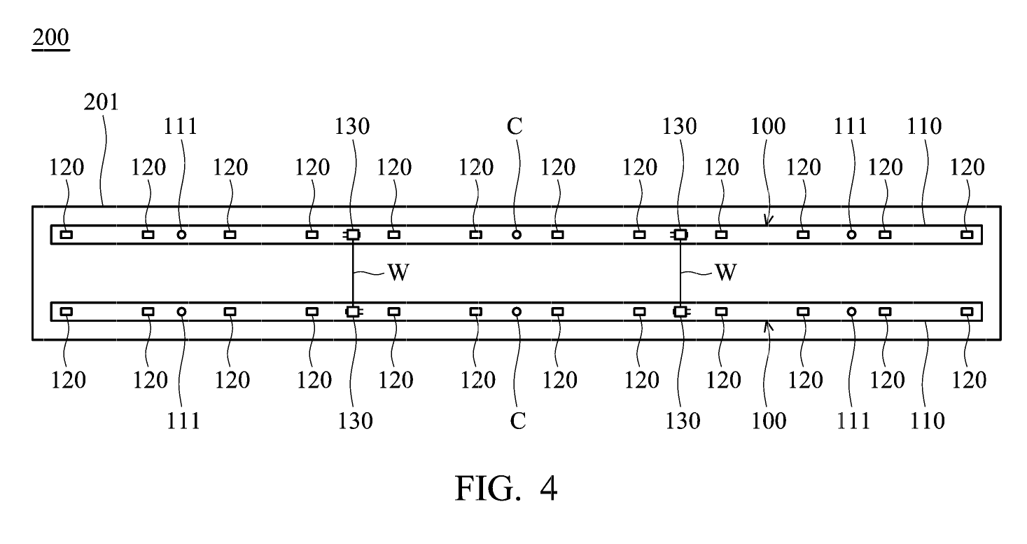

Referring to FIG. 4, when being assembled on a holder 201 to form a direct-type illumination device 200, multiple light bar structures 100 may be correspondingly arranged on the holder 201 and do not need to face the same direction (i.e. the light bar structures 100 are not provided with directionality) as the power input portions 130 of each light bar structure 100 are symmetrical to the center C of the circuit board 110. The power input portions 130 of two adjacent light bar structures 100 are in alignment. At this point, each light bar structure 100 can be fixed to the holder 201 through the fixing portions 111 of the circuit board 110. Then, multiple wires W in short length are respectively connected to the power input portions 130 of two adjacent light bar structures 100, achieving electrical connection between the light bar structures 100.

Accordingly, the disclosed direct-type illumination device 200 (or light bar structure 100) has the following advantages. As all the light bar structures 100 can be correspondingly arranged on the holder 201 and do not need to face the same direction, assembly of the direct-type illumination device 200 is simplified. Moreover, as the wires W can be easily connected between the power input portions 130 of the two adjacent light bar structures 100, wire management of the direct-type illumination device 200 is less difficult. Further, as the power input portions 130 of each light bar structure 100 are symmetrical to the center C of the circuit board 110, an impedance distribution of the light-emitting diodes 120 of the light source module is more uniform, effectively achieving a uniform distribution of illumination brightness for the light-emitting diodes 120 (or light source module).

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light bar structure, comprising:
a circuit board;
a light source module disposed on the circuit board; and
at least two power input portions disposed on the circuit board and in parallel connection, wherein the at least two power input portions are electrically connected to the light source module.

2. The light bar structure as claimed in claim 1, wherein the at least two power input portions are symmetrical to a center of the circuit board.

3. The light bar structure as claimed in claim 1, wherein each power input portion comprises a connector.

4. The light bar structure as claimed in claim 1, wherein each power input portion comprises two solder wire contacts.

5. The light bar structure as claimed in claim 1, wherein the circuit board comprises at least one fixing portion assisting in fixing the light bar structure.

6. The light bar structure as claimed in claim 1, wherein the light source module comprises a plurality of parallel light-emitting diodes in parallel connection with the at least two power input portions.

7. A direct-type illumination device, comprising:
a holder; and
a light bar structure disposed on the holder, comprising:
a circuit board;
a light source module disposed on the circuit board; and
at least two power input portions disposed on the circuit board and in parallel connection, wherein the at least two power input portions are electrically connected to the light source module.

8. The direct-type illumination device as claimed in claim 7, wherein the at least two power input portions are symmetrical to a center of the circuit board.

9. The direct-type illumination device as claimed in claim 7, wherein each power input portion comprises a connector.

10. The direct-type illumination device as claimed in claim 7, wherein each power input portion comprises two solder wire contacts.

11. The direct-type illumination device as claimed in claim 7, wherein the circuit board comprises at least one fixing portion fixing the light bar structure to the holder.

12. The direct-type illumination device as claimed in claim 7, wherein the light source module comprises a plurality of parallel light-emitting diodes in parallel connection with the at least two power input portions.
